(19) United States
(12) Patent Application Publication
(10) Pub. No.: US 2008/0137639 A1
(43) Pub. Date: Jun. 12, 2008

(54) Localization of Telephone Subscribers Connected to a Packet Network

(76) Inventor: Wolfgang Horstmann, Krailling (DE)

Correspondence Address: BELL, BOYD & LLOYD, LLP, P.O. BOX 1135, CHICAGO, IL, 60690, US

(21) Appl. No.: 10/582,597

(22) PCT Filed: Dec. 2, 2004
(86) PCT No.: PCT/EP04/53228

§ 371 Date: Jun. 29, 2007

(30) Foreign Application Priority Data
Dec. 12, 2003 (DE) 103 58 339.4

(51) Int. Cl. H04L 12/56

(52) U.S. Cl. 370/352

(57) ABSTRACT

The invention relates to a method for the localization of a telephone terminal for a voice link conducted via a packet network. The telephone terminal is registered with the call number and allocated localization information in a server which is localized in the packet network. If the localization of the telephone terminal is triggered as a result of a voice link, the localization information associated with the call number is queried in the server in order to localize the telephone terminal using the call number of the telephone terminal is determined using the localizing information. The invention enables known terminal localization performance criteria for TDM networks to also be used directly for telephone terminals which are connected to a packet network.

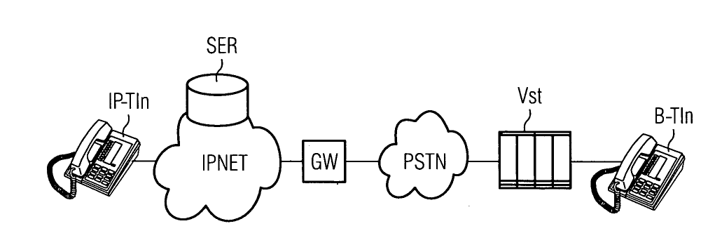

### CROSS REFERENCE TO RELATED APPLICATIONS

This application is the US National Stage of International Application No. PCT/EP2004/053228, filed Dec. 2, 2004 and claims the benefit thereof. The International Application claims the benefits of German application No. 10358339.4 DE filed Dec. 12, 2003, both of the applications are incorporated by reference herein in their entirety.

### FIELD OF INVENTION

The invention relates to a method for locating a telephone terminal in the case of a voice connection conducted via a packet network.

### BACKGROUND OF INVENTION

The invention lies in the field of switching technology and relates in particular to the provisioning of service features for voice communication via packet networks.

A side-effect of the rapid development of packet-based networks, including in particular the networks based on the IP (Internet Protocol) protocol, is that real-time traffic, such as e.g. voice traffic, is increasingly being handled via packet networks in addition to the data traffic. At the same time efforts are being directed at providing all the service features that are known from telephony via circuit-switched networks (also referred to in this context as TDM (Time Division Multiplexing) networks) as far as possible also for voice communication via packet networks.

A service feature known from TDM networks is the localization of telephone subscribers on the basis of their call numbers. Originally the call numbers were chosen so that the position of the corresponding terminal or telephone subscriber could be deduced on the basis of the composition of said numbers. In the meantime this rigid link has been abandoned, at least in the German network, in favor of service features such as a subscriber-related instead of location-related number assignment. In today's TDM networks the localization is normally performed by means of localization information which is assigned to a call number. This localization information is typically stored in switching systems for terminals controlled by the respective switching system. The localization information can then be queried or the localization performed via the switching system.

### SUMMARY OF INVENTION

This function, i.e. the localization of terminal devices, is currently not available for terminals that are connected directly to a packet network, e.g. so-called IP telephones, which is to say telephones that send their voice data directly by means of the IP protocol and exchange signaling using, for example, the SIP protocol, or PCs equipped with voice functionality.

An object of the invention is to specify a method for locating telephone terminals which also permits the localization of telephone terminals connected directly to packet networks.

This object is achieved by a method according to the independent claims.

According to the invention a server is provided in which telephone subscribers are registered together with their call number and localization information assigned to the call number. In a voice connection in which the calling subscriber is to be identified, in the case of an emergency call for example, the localization of the calling telephone terminal is initiated during the voice connection (in the course of the connection setup, for example). In the course of said localization the call number of the calling telephone terminal is used in a query to the server to interrogate the localization information assigned to the call number. Finally, the position of the calling telephone terminal is determined on the basis of said localization information.

The method according to the invention is advantageous in particular with regard to telephone terminals connected directly to the packet network, such as, for example, IP telephones or PCs equipped with voice functionality.

In the event that the subscriber called in the course of the voice connection is connected to a circuit-switched network or TDM network, the query to the server can be initiated in the switching system controlling the calling terminal. This query is then transmitted to the server in which the localization information is stored. The call number of the calling telephone terminal can then be sent to the called terminal or a switching system responsible for said terminal using, for example, e-mail, SMS or fax.

During the registration of the telephone terminal the packet network address of the telephone terminal can additionally be stored in the server. This additional information can be used, for example, for checking the consistency of the information stored in the server.

### BRIEF DESCRIPTION OF THE DRAWING

The subject matter of the invention will be explained in more detail below in the context of an exemplary embodiment with reference to a FIGURE.

The FIGURE shows an IP telephone IP-Tln which is connected to an IP network IPNET.

### DETAILED DESCRIPTION OF INVENTION

A server SER for registering telephone terminals is provided in said IP network IPNET. The server SER is operated for example by an internet service provider. The user of the IP telephone IP-Tln is registered with the server SER. In this case the registration can be one actively undertaken by the user of the IP telephone IP-Tln or an automatic registration. The FIGURE illustrates a scenario for the situation in which the called subscriber is a PSTN (Public Switched Telephone Network) subscriber, i.e. a subscriber connected to the PSTN network via a local exchange Vst. In a voice connection between the IP telephone IP-Tln and the telephone of the called subscriber B-Tin the exchanged data must be adapted for the transmission over different networks. Said adaptation is performed in a gateway GW which adapts data coming from the IP network IPNET for the transmission over the PSTN network PSTN and similarly adapts data going in the opposite direction. According to the invention the position of the IP telephone IP-Tln is located. The called subscriber B-Tln is, for example, an emergency call center. During the connection setup a connection setup message is transmitted from the IP telephone IP-Tln to the called terminal B-Tln. Upon receiving the connection setup message, the local exchange VST of the called subscriber B-Tln establishes that a connection to the emergency call center B-Tln is to be set up, but that the information regarding the position of the calling subscriber or, as the case may be, IP telephone IP-Tln, which information is to be determined when calls are made to the emergency call center, is not available. In the local exchange VST the localization of the calling subscriber or, as the case may, the latter's terminal IP-Tln is thereupon initiated. Toward that end, a message is sent to the server SER, by means of which message the desired information is queried on the basis of the call number of the calling subscriber IP-Tln. A message of said kind is transmitted back via the PSTN network to the gateway GW and adapted there for transmission via the IP network IPNET. The following options, for example, are possible with regard to reaching the server SER by means of the message.
The message for querying the desired localization information using the call number of the calling subscriber IP-Tln is first transmitted to the IP telephone IP-Tln and forwarded from there to the server SER.
Alternatively, multicast can be used, for example, in order to propagate the message to possible destinations through the network. The message will then be discarded by all recipients except the server SER. It can be provided, for example, that a server SER for registering telephone terminals is provided for each subnetwork. In this case a multicast can be performed for the corresponding subnetwork.
It is also conceivable that the addresses of servers SER which store the localization information for terminals connected directly to the IP network are made available (when a server SER of said kind is set up, for example) to subscribers or terminals that generally require the localization information, such as, for example, emergency services or emergency call centers, so that the called subscriber B-Tln already has the server address.

Upon receiving the message requesting the transfer of the localization information, the server SER sends said localization information, possibly together with the telephone number of the calling subscriber A-Tln (in the interest of better control), to the called subscriber B-Tln or the associated local exchange VST. This can happen in that this information is first transmitted via the IP network IPNET, then adapted in the gateway GW, and finally transmitted via the PSTN network PSTN to the destination, where the information is analyzed and the position of the calling subscriber IP-Tln determined.

1.-9. (canceled)

10. A method for locating a telephone terminal having a voice connection via a packet network, comprising:
registering the telephone terminal with a server operated by an internet service provider;
storing a call number of the telephone terminal and localization information assigned to the call number in the server during registration;
initiating the localization of the telephone terminal during the voice connection;
querying the server for the localization information assigned to the call number in order to locate the telephone terminal; and
determining the position of the telephone terminal based on the localization information.

11. The method as claimed in claim 10, the server is located in the packet network.

12. The method as claimed in claim 10, wherein the telephone terminal is directly connected to the packet network.

13. The method as claimed in claim 12, wherein the packet network is based Internet Protocol and the position of an IP telephone or a computer equipped for voice communication is determined.

14. The method as claimed in claim 10, wherein the localization is initiated during a connection setup of the voice connection.

15. The method as claimed in claim 14,
wherein the voice connection is between the telephone terminal and a called terminal,
wherein the called terminal is connected to a Time Division Multiplexing network, and
wherein the localization is initiated in a switching system that switches incoming calls to the called terminal.

16. The method as claimed in claim 15, wherein the localization information is sent from the server via an e-mail, a Short Messaging Service or a fax to the called terminal.

17. The method as claimed in claim 15, wherein the localization information is sent from the server via an e-mail, a Short Messaging Service or a fax to the switching system.

18. The method as claimed in claim 15, wherein a packet network address of the telephone terminal is stored in the server during the registration of the telephone terminal.

19. The method as claimed in claim 16, wherein the called terminal is part of an emergency call center.

20. The method as claimed in claim 10,
wherein the voice connection is between the telephone terminal and a called terminal,
wherein the called terminal is connected to a Time Division Multiplexing network, and
wherein the localization is initiated in a switching system that switches incoming calls to the called terminal.

21. The method as claimed in claim 10, wherein the localization information is sent from the server via an e-mail, a Short Messaging Service or a fax to the called terminal.

22. The method as claimed in claim 10, wherein the localization information is sent from the server via an e-mail, a Short Messaging Service or a fax to the switching system.

23. The method as claimed in claim 10, wherein a packet network address of the telephone terminal is stored in the server during the registration of the telephone terminal.

24. The method as claimed in claim 10, wherein the called terminal is part of an emergency call center.

25. A method for locating a telephone terminal having a voice connection via a packet network, comprising:
registering the telephone terminal with a server operated by an internet service provider;
storing a call number and a packet network address of the telephone terminal in the server during registration;
storing localization information assigned to the call number in the server during registration;
initiating the localization of the telephone terminal during the voice connection;
querying the server for the localization information assigned to the call number in order to locate the telephone terminal; and
determining the position of the telephone terminal based on the localization information.

26. The method as claimed in claim 25,
wherein the voice connection is between the telephone terminal and a called terminal,
wherein the called terminal is connected to a Time Division Multiplexing network, and
wherein the localization is initiated in a switching system that switches incoming calls to the called terminal.

27. The method as claimed in claim 25, further comprising sending the localization information from the server via an e-mail, a Short Messaging Service or a fax to the called terminal.

28. The method as claimed in claim 25, further comprising sending the localization information from the server via an e-mail, a Short Messaging Service or a fax to the switching system.

29. The method as claimed in claim 25, wherein the called terminal is part of an emergency call center.
